(19) United States
(12) Patent Application Publication
(10) Pub. No.: US 2010/0213377 A1
(43) Pub. Date: Aug. 26, 2010

(54) Method, Apparatus and Kit for Measuring Optical Properties of Materials

(76) Inventors: Dan Yakir, Kiryat Ekron (IL); Asher Hoter, Petach Tikva (IL); Abraham Kribus, Rehovot (IL); Irina Vishnevetsky, Ness Ziona (IL); Eyal Rotenberg, Kibbutz Eilon (IL)

Correspondence Address: The Law Office of Michael E. Kondoudis, 888 16th Street, N.W., Suite 800, Washington, DC, 20006, US

(21) Appl. No.: 12/664,687

(22) PCT Filed: Jun. 19, 2008
(86) PCT No.: PCT/IL08/00834

§ 371 Date: Dec. 15, 2009

Related U.S. Application Data
(60) Provisional application No. 60/945,142, filed on Jun. 20, 2007.

(51) Int. Cl. G01J 5/02; G01N 21/17

(52) U.S. Cl. 250/341.8; 250/338.1; 250/340

(57) ABSTRACT

A kit, apparatus and method are presented for use in measuring an optical property of a sample. The kit comprises at least one reference unit, having a reference surface of a directional emissivity of a certain value; and main and auxiliary chambers, each defining an optical window allowing passage of electromagnetic radiation therethrough. The main chamber is configured to define a region thereof for accommodating the reference unit and the sample, and is configured to screen this region from external radiation.

### CROSS-REFERENCE TO RELATED APPLICATIONS

This application is a National Stage of International Application No. PCT/IL2008/000834, filed Jun. 19, 2008, which claims the benefit of priority from U.S. Provisional Application No. 60/945,142, filed Jun. 20, 2007.

### FIELD OF THE INVENTION

This invention relates to a method, apparatus and kit for measuring optical properties of surface samples, including natural objects, and including the thermal radiation range.

### REFERENCES

The following references are considered to be pertinent for the purpose of understanding the background of the present invention:
1. Fuchs, M. and Tanner, C. B., 1966, “Infrared thermometry of vegetation”, Agronomy Journal 58, pp. 597-601.
2. Buettner, K. J. K. and Kern, C. D., 1965, “The determination of infrared emissivities of terrestrial surfaces”, Journal of Geophysical Research 70, pp. 1329-1337.
3. Especel, D. and Mattel, S., 1997, “Total emissivity measurements without use of an absolute reference”, Infrared Physics & Technology 37, pp. 777-784.
4. Togawa, T., 1989, “Non-contact skin emissivity: measurement from reflectance using step change in ambient radiation temperature”, Clinical Physical Physiological Measurements 10, pp. 39-48.
5. Huang J. and Togawa, T., 1995, “Improvement of imaging of skin thermal properties by successive thermographic measurements at a stepwise change in ambient temperature”, Physiological Measurements 16, pp. 295-301.
6. Togawa, T. et al., 2002, “Imaging of skin thermal properties with estimation of ambient radiation temperature”, IEEE Engineering in Medicine and Biology, pp. 49-55.
7. Blätte M., 1970, “A novel technique for measuring reflectivities in the near infrared”, Optics Communications 1 pp. 460-462.
8. U.S. Pat. No. 3,401,263
9. U.S. Pat. No. 5,098,195
10. FR 2,752,056
11. Sparrow, E. M. and Albers, L. U. and Eckert, E. R. G., 1962, “Thermal radiation characteristics of cylindrical enclosures”, Journal of Heat Transfer, C84, pp. 73-81
12. Sparrow, E. M. and Cess, R. D., Radiation Heat Transfer (Brooks/Cole Publishing Company, Belmont, Calif., 1967).
13. Kribus A., Vishnevetsky I., Rotenberg E., Yakir D., Applied Optics, vol. 42, 10, page 1839, 2003
14. Modest M. F., Radiative Heat Transfer (Academic Press, California, 2003).

### BACKGROUND

All materials emit electromagnetic radiation, and the emitted spectrum range and the radiant flux intensity vary depending on the temperature and properties of the emitting surface. Surfaces of a near room temperature emit so-called thermal radiation (TR) (in some cases also called far infrared) in a thermal spectral range, from 4 to 100 μm. Most of the emitted thermal radiation energy lies in a range from 8 to 12 μm.

Interaction between radiation and an object involves several processes including emission, absorption, reflection and transmission of radiation; this interaction is generally characterized by “optical properties” of the object. In a case of an opaque material the first three mechanisms are most important. Knowledge of the optical properties of surfaces in the thermal range is desired in many fields, for example in medical, security and military fields, in various production industries, in weather forecasting and other applications. The emissivity property is widely used for example for non-contact measurements of surface temperature.

Some of the surface optical properties are defined through comparison of behavior of the real surface with behavior of ideal “black body” (BB) element. The BB element absorbs all incoming radiation while emits radiation according to its temperature. Optical properties of most natural surfaces depend on many parameters, including radiation wavelength, radiation direction, surface's temperature, degree of roughness, chemical, composition, etc. Radiation can be either illuminating, i.e. radiation incident on a surface, or illuminated, i.e. radiation leaving the surface. Integrating over all or some wavelengths and directions allows obtaining various averaged optical properties of the surface.

The optical property of emissivity is an example of surface's inherent, fundamental, property. An emissivity coefficient, or simply emissivity, is defined as a fraction amount of radiation energy emitted by a surface at a given temperature: the fraction is obtained by comparison with radiation energy emitted by BB having the same temperature. By this definition, the emissivity of BB equals 1.

Accordingly, a directional spectral emissivity is defined as a ratio between a sample's directional spectral emitted radiation and a BB's directional spectral emitted radiation having the same temperature. The sample's directional spectral intensity is the intensity of radiation of wavelength λ emitted by the sample at temperature T in an azimuthal direction θ and a zenithal direction β (this direction will be denoted by index D in below formulae). Hence, the directional spectral emissivity is defined as a ratio:

$${ɛ}_{λ}^{D} = \frac{{i}_{λ}^{D} ( λ , β , θ , T )}{{i}_{BB , λ}^{D} ( λ , β , θ , T )} \cdot \qquad \text{(B-1)}$$

The BB's directional spectral intensity i_{BB,λ}^{D}(λ,β,θ,T) is distributed according to the Planck's law:

$${i}_{BB , λ}^{D} ( λ , β , θ , T ) = \frac{2 {C}_{1}}{{λ}^{5} ( {e}^{{C}_{2} / λ T} - 1 )} cos β \cdot \qquad \text{(B-2)}$$

In (B-2) C₁ and C₂ are constants. Integration of B-2 over all radiation spectrum and all directions gives the total amount of radiation intensity emitted by a unit surface area.

The intensity of BB radiation in a spectral region [λ₁, λ₂] is denoted as i_{BB,λ}_{₁}_{-λ}_{₂}. It can be presented as:

i_{BB,λ}_{₁}_{-λ}_{₂}=i_{BB}F_{T,λ}_{₁}_{-λ}_{₂}, (B-3)

where F_{T,λ}_{₁}_{-λ}_{₂} is a fraction of total black body intensity lying in region [λ₁, λ₂] at surface temperature T. This fraction is the ratio between an integral of (B-2) over spectral range [λ₁,λ₂] and all radiation directions and the total intensity of BB emitted radiation. The total intensity of black body emitted radiation (i.e. the BB intensity) is given by the Stefan-Boltzmann's law: i_{BB}=σT⁴ for a BB having temperature T. The directional intensity of a BB surface is i_{BB}^{D}=σT⁴/π. In the above equations and in the rest of this document the subscript λ means “at a wavelength λ.”, superscript D means “in a direction D from the sample”, subscript BB means “blackbody”.

A surface absorbance of the illuminating radiation is another example of the surface's property, and generally changing with radiation wavelength and angle between the propagating radiation and the surface. Consequently, a surface spectral directional absorbance α_{λ}^{D} is also used. The Kirchhoff's law establishes a relation between the surface directional spectral emissivity and the surface spectral directional absorbance, for the case where the directions of radiation propagation are opposite:

ε_{λ}^{D}=α_{λ}^{-D}. (B-4)

While Emissivity (and Superscript D) Relates to the Radiation Directed from the sample, the absorbance (and superscript −D) relates to the radiation directed towards the sample.

Considering radiation incident on a sample surface from a certain direction d, not necessarily related to D, this radiation is reflected with a certain angular distribution into a hemisphere faced by the sample. A directional hemispherical spectral reflectivity ρ_{λ}^{d,h} is defined as a ratio between the intensity of this incident directional radiation and the intensity of the radiation reflected into the hemisphere, at the wavelength λ. For opaque surfaces, incident directional radiation can be absorbed and/or reflected, therefore:

α_{λ}^{d}+ρ_{λ}^{d,h}=1, (B-5)

In (B-5) and in the rest of this document superscript “h” means “hemispherical”.

A relation between the surface directional spectral emissivity and the surface directional hemispherical spectral reflectivity can be obtained using (B-4) and (B-5) for opaque surfaces for opposite incident and emission directions:

ρ_{λ}^{-D,h}=1−ε_{λ}^{D}, (B-6)

Typically, methods for measuring surface emissivity are either direct or indirect: while direct methods rely on measurement of radiation emitted by a surface, indirect methods rely on measurement of radiation reflected from a surface. The reflected radiation is typically produced by an external source(s).

Considering typical measurement techniques, the following is observed. Generally, radiation leaving a surface and reaching a detector positioned in a direction D is a superposition of two radiations: first, radiation emitted by the investigated surface, and, second, radiation reached that surface from its surroundings and reflected towards the detector. For wavelength band [λ₁, λ₂], this effect is pronounced in the following equation based on definitions of emissivity and reflectivity:

$$\begin{matrix}{i}^{D} ( {\vec{Ω}}_{D} ) = {\int }_{{λ}_{1}}^{{λ}_{2}} {ɛ}_{λ}^{D} ( {\vec{Ω}}_{D} ) {i}_{BB , λ} ( λ , {\vec{Ω}}_{D} , T ) d λ + \\ {\int }_{⋂} {\int }_{{λ}_{1}}^{{λ}_{2}} {ρ}_{λ}^{d , D} ( λ , {\vec{Ω}}_{d} , {\vec{Ω}}_{D} , T ) {i}_{B , λ} ( λ , {\vec{Ω}}_{d} ) d λ \hat{n} \cdot {\vec{Ω}}_{d} d {\vec{Ω}}_{d} ,\end{matrix} \qquad \text{(B-7)}$$

Here i^{D}(\vec{Ω}_{D}) is the directional intensity of radiation propagating in the direction D (i.e. in the direction of the detector), \vec{Ω}_{D} is an angle between the direction D and a normal to the sample's surface \hat{n}; i_{BB,λ}(λ,\vec{Ω}_{d},T) is spectral angular intensity distribution of the radiation emitted by the surface having temperature T to the surroundings; ρ_{λ}^{d,D}(λ,\vec{Ω}_{d},\vec{Ω}_{D},T) is a bidirectional, temperature-dependent, spectral reflectivity of the sample, for radiation incident onto the sample from direction d and reflected in the direction D; the integration in (B-7) takes into account reflections in the direction of the detector from all possible directions d. The radiation emitted by the sample's surroundings is called background radiation (hence “B” in the subscript); it can reach the sample surface only from a hemisphere faced by the sample surface. In (B-7) the first integral corresponds to the amount of emitted radiation reaching the detector from the sampled surface, and the second integral corresponds to the amount of reflected radiation reaching the detector; the latter integral is double, because the reflected radiation is generally due to the hemisphere of background radiation.

Equation (B-7) can be written in a different form:

i_{λ}_{₁}_{-λ}_{₂}^{D}=ε_{λ}_{₁}_{-λ}_{₂}^{D}i_{BB,λ}_{₁}_{-λ}_{₂}^{D}+ρ_{λ}_{₁}_{-λ}_{₂}^{h,D}i_{B,λ}_{₁}_{-λ}_{₂}^{h}. (B-8)

Here Directional Emissivity ε_{λ}_{₁}_{-λ}_{₂}^{D} is the Directional Emissivity for Light at wavelength range [λ₁,λ₂] emitted in the direction D of the detector; the emissivity is multiplied by the respective intensity of BB; hemispherical directional reflectivity ρ_{λ}_{₁}_{-λ}_{₂}^{h,D} is a coefficient characterizing an input of background radiation into the directional intensity of the reflected radiation; i_{B,λ}_{₁}_{-λ}_{₂}^{h} is an intensity of the background radiation incident on the sample from the hemisphere faced by the sample, i.e. it is the angularly distributed spectral intensity of radiation integrated over the range of possible incident angles and wavelengths. In contrast to the directional hemispherical reflectivity ρ_{λ}_{₁}_{-λ}_{₂}^{-D,h} the hemispherical directional reflectivity ρ_{λ}_{₁}_{-λ}_{₂}^{h,D} is a function not only of the sample surface material and the angle between the surface and selected direction, but also it is a functional of the angular distribution of the incident input light. To underline the fact that the hemisphere light propagates in opposite directions in the case of directional hemispherical and hemispherical directional reflectivity, the hemispherical directional reflectivity ρ_{λ}_{₁}_{-λ}_{₂}^{h,D} is written as ρ_{λ}_{₁}_{-λ}_{₂}^{-h,D} further on.

A relation between the directional hemispherical reflectivity, which can also be averaged over the wavelength range [λ₁,λ₂], and the hemispherical directional reflectivity was investigated in [13]. It was concluded there that in certain cases using an assumption ρ^{-h,D}=ρ^{-D,h} is justified, as this assumption becomes not accidentally fulfilled. In particular, for this, at least one of the following two conditions needs to be true (a) the surface is a diffuse reflector (b) the background radiation is diffuse i.e. the background radiation comes with equal intensity i_{B,λ}(λ,\vec{Ω}_{d}) from all hemisphere directions d.

If the equality ρ^{-h,D==ρ}^{-D,h} is fulfilled, equations (B-6) and (B-8) can be combined into one, which can be either spectral or averaged over a wavelength band:

i^{D}=ε^{D}i_{BB}^{D}+(1−ε^{D})i_{B}^{h}. (B-9)

### General Description

Determining optical properties of a sample, e.g. of the surface emissivity, absorbance and/or reflectivity, either normal or other directional, is of high interest in many applications. Measuring the radiation intensity coming from the sample, however, does not immediately yield a certain optical property. This is because radiation emitted by the sample is mixed with at least an ambient radiation reflected by the sample. This mixing, generally, can not be neglected. When the sample surface temperature is close to the ambient temperature, for example room temperature, and there are no strong external sources, taking into account both terms of the sum in (B-8) becomes especially important for the emissivity or reflectivity or absorbance determination. This allows determination of the optical properties with higher accuracy and possibly precision. Also, for accurate determination of the optical properties, directional effects and optical properties variabilities generally can not be neglected.

In many cases for the determination of the optical properties (B-9) is used. However, (B-9) is justified only for diffuse sample surfaces and/or diffuse background radiations. A systematic error may arise due to directional effects, for non-diffuse sample surfaces and inhomogeneous ambient conditions. Nevertheless, the directional effects are typically not considered, and the assumption of a diffuse sample surface or a diffuse (i.e. uniform) background radiation is typically explicitly or implicitly used. For legitimation of this assumption the appropriate conditions need to be provided; otherwise the determination of the optical properties may be performed with a significant error. For example, using for a calculation of optical properties natural objects of high emissivity determined with uncertainty of more than 0.5% can lead to inaccuracy of more than 20% in determination of some energy components of the energy balance.

The present invention provides a novel measurement technique utilizing a change in the intensity of an alternated substantially diffuse background radiation reflected by a reference unit and a sample.

The reference unit may have a surface of an optical property of a (first) certain value and, possibly, an open cavity with an inner surface of a predetermined shape and of the optical property of the same first certain value. The cavity's inner or virtual surface may have the optical property of a second certain value when a ratio between the first and second values is known.

The alternation of the background radiation may be produced by a radiation source operating to produce an alternating radiation power or operating to produce a constant radiation power being alternatively intercepted during its propagation towards the sample and reference. Except for this alternation, the background radiation is kept stationary and the sample and reference are screened from uncontrolled radiation by a chamber. In some embodiments, the sample and reference unit are positioned sufficiently close to each other so as to be exposed to approximately the same background radiation. For example, the sample and reference may be placed side by side in one chamber port. The alternating radiation source can be positioned in the same chamber with the sample and reference; or it may be placed in another chamber (as in some preferred embodiments).

The invented technique enables measurement of the optical properties of the sample while not relying on a change of the sample's or reference's temperature. Hence, for measuring the optical properties of the sample at a specific temperature, the alternating component of the background radiation in some embodiments is selected to be sufficiently low so as not to cause the sample or the reference temperature change. In some of the experiments conducted by the inventors the alternating background radiation was created by a miniature SiC heater and a shutter. If a substantial change of sample's temperature nevertheless takes place, as it can for example happen for thin high emissivity samples, the invented technique enables the measurement of the optical properties and finding temperature corrections for it by time extrapolation or time averaging of data obtained in cyclic measurements.

The invented technique can be effectively used despite the invalidity of (B-9) in case of the presence of directional effects. To this end, the background radiation is diffused in the chamber, which for example is an integrating sphere (as in some preferred embodiments), or in this chamber and also in another chamber, where the latter chamber may also be an integrating sphere (again, as in some preferred embodiments).

The invented technique can utilize a camera positioned, oriented and focused to image both the sample and the reference in the same shot(s) or it can utilize multiple cameras. Typically the camera is sensitive to a region of infrared wavelengths in which optical properties are to be determined. For example, camera can be sensitive to wavelength(s) included in the range of wavelengths from 8 to 12 microns; or, alternatively, to a region intersecting with the latter range; or, alternatively, to a region containing this range. The camera's resolution allows distinguishing the sample and the reference, and the reference's certain optical property surface and cavity opening, if the latter is present.

Turning back to the reference unit, it may be also configured to have a cavity with an optical window or an opening allowing passage of electromagnetic radiation therethrough into the cavity. In some embodiments, the real surfaces of the reference unit (including cavity walls) are diffusively and highly reflective. The cavity may be, for example, of a cylindrical, or spherical, or conical shape. The shape of the cavity, its form and dimensions, predetermine an emissivity εᵣ of the reference surface (to some extent).

According to one broad aspect of the present invention, there is provided a kit for use in measuring an optical property of a sample. The kit includes at least one reference unit, having a reference surface of a directional emissivity of a certain value (less than 1); and main and auxiliary chambers, each defining an optical window allowing passage of electromagnetic radiation therethrough. The main chamber is configured to define a region thereof for accommodating the reference unit and the sample and is configured to screen this region from external radiation (i.e. ambient light, e.g. from the sun). The kit may be useful for measuring such an optical property as for example an emissivity (e.g. a directional or any other emissivity), and/or reflectivity (e.g. a directional hemispherical reflectivity). Considering the reference directional emissivity, it is of the certain value which is less than 1.

The kit may include an imager capable of obtaining image data indicative of intensity distribution of detected electromagnetic radiation. The imager may be adapted to receive images at wavelength(s) included in a range of wavelengths from 8 to 12 microns; or, alternatively, at a range of wavelengths intersecting with the latter range of wavelengths from 8 to 12 microns; or, alternatively, at a range of wavelengths containing the range of wavelengths from 8 to 12 microns.

The kit may include a radiation source mountable inside the auxiliary chamber. The kit may include an imager capable of obtaining image data indicative of intensity distribution of detected electromagnetic radiation, the radiation source and the imager being operative in substantially intersecting wavelength regions of infrared electromagnetic radiation.

The radiation source and the imager may be configured to be operative in substantially the same wavelength region. The radiation source and the imager may be operative at wavelength(s) included in a range of wavelengths from 8 to 12 microns; or, alternatively, at a range of wavelengths intersecting with the latter range of wavelengths from 8 to 12 microns; or, alternatively, at a range of wavelengths containing the range of wavelengths from 8 to 12 microns.

In some of the preferred embodiments, the most of inner surface of the main chamber is diffusively reflective. This surface may be covered with a high reflectivity (e.g. at least 80%, for example 85%, 90%, or 95%), for example using a metal layer coating. In some of the preferred embodiments this surface may be substantially spherical.

The inner surface of the auxiliary chamber may be covered with a high reflectivity layer. This inner surface may be substantially spherical.

The reference unit may have a cavity with an optical window allowing passage of electromagnetic radiation therethrough into this cavity. The cavity's optical window can define the reference surface. Most of the inner surface of this cavity may be diffusively reflective. It may be configured for diffusive reflection of radiation coming into the cavity through the cavity optical window and further leaving the cavity. The cavity inner surface may include a high reflectivity layer.

The kit of may include a control system (a computing device, e.g. programmed computer) adapted to calculate at least one parameter related to the optical property of the sample surface from the obtained image data. Such a parameter may includes at least one of emissivity (e.g. directional emissivity), reflectivity (e.g. directional hemispherical reflectivity), an intensity of radiation propagating from the sample to the imager, an intensity of radiation propagating from the reference surface to the imager.

The kit of may include a tangible medium carrying a record of a software product preprogrammed for processing image data indicative of intensity distribution of electromagnetic radiation, this software product being capable of calculating at least the intensity distribution of electromagnetic radiation. The software product may be further capable of calculating at least one parameter related to (i.e. characterizing) the optical property of the sample.

The software product may utilize, for the calculation of the directional emissivity of the sample εₛ, a formula

$$\frac{1 - {ɛ}_{s}}{1 - {ɛ}_{r}} = \frac{{{i}_{s}}^{( 1 )} - {{i}_{s}}^{( 2 )}}{{{i}_{r}}^{( 1 )} - {{i}_{r}}^{( 2 )}} ,$$

wherein εᵣ is the certain value of the directional emissivity of the reference surface, iₛ⁽¹⁾ and iₛ⁽²⁾ are, respectively, first and second intensities of radiation propagating from the sample to the imager in cases of a first and a second amounts of radiation reaching the above specified region, iᵣ⁽¹⁾ and iᵣ⁽²⁾ are, respectively, first and second intensities of radiation propagating from the reference surface to the imager in the cases of the first and the second amounts of radiation reaching the region.

It should be understood the term formula includes equivalents of the above expression.

The cavity of the reference unit may be selected to be of a cylindrical shape with diffuse inner surface. The geometrical dimensions of the cylinder predetermine a relationship between the directional (e.g. normal) emissivity of the material covering the cavity and the directional (e.g. normal) emissivity (effective or apparent emissivity) of the cavity's virtual surface.

The kit may include a shutter mountable on at least one of the main and auxiliary chambers, where the shutter is configured and operable to affect a degree of openness of the optical window of at least one of the chambers. The shutter may thereby enable controlling passage of radiation through the optical window.

The kit may include a set of the reference units, and the set may define a set of the reference surfaces at least two of which are of different shapes.

The kit may include at least one of the following:

an imager capable of obtaining image data indicative of intensity distribution of electromagnetic radiation, the imager being operative at wavelength(s) included in a range of wavelengths from 8 to 12 microns; or, alternatively, at a range of wavelengths intersecting with the latter range of wavelengths from 8 to 12 microns; or, alternatively, at a range of wavelengths containing the range of wavelengths from 8 to 12 microns, the imager to be accommodated so as to have the region in focus;

a tangible medium carrying a record of a software product preprogrammed for processing image data indicative of intensity distribution of electromagnetic radiation, the software product being capable of calculating the intensity distribution of electromagnetic radiation and/or a parameter related to the optical property.

The kit may include a filter passing substantially a spectral band of electromagnetic radiation in which the optical property is to be detected.

According to another broad aspect of the invention, there is provided an apparatus for measuring an optical property of a sample, the apparatus including at least one reference unit having a reference surface of a directional emissivity of a certain value; and main and auxiliary chambers, each of the chambers defining an optical window allowing passage of electromagnetic radiation therethrough. The auxiliary chamber and the main chamber are connected by a shuttable optical pass allowing controllable passage of illuminating radiation from the auxiliary chamber through its optical window into the main chamber through its optical window. The main chamber is configured to define a region thereof for accommodating the reference unit and the sample and is configured to screen this region from external radiation. The apparatus is configured to direct a portion of the illuminating radiation to the region. The apparatus may be useful for measuring such an optical property as emissivity and reflectivity.

The reference unit may be positioned so that the reference surface is accommodated within the sample and reference containing region and oriented so as to expose the reference surface to at least a portion of the illuminating radiation.

The apparatus may include an imager capable of obtaining images indicative of intensity distribution of electromagnetic radiation. The imager may be operative at wavelength(s) included in a range of wavelengths from 8 to 12 microns; or, alternatively, at a range of wavelengths intersecting with the latter range of wavelengths from 8 to 12 microns; or, alternatively, at a range of wavelengths containing the range of wavelengths from 8 to 12 microns. It may be accommodated so as to have the sample and reference containing region in its field of view. The imager may be configurable or may be configured to be focused on the region.

The apparatus may include a shutter configured and operable to affect a degree of openness of the shuttable optical pass. A controllable passage of the illuminating radiation from the auxiliary chamber into the main chamber therefore may be enabled. The shutter may be shiftable between its closed state, in which the passage of the illuminating radiation is blocked, and its open state, in which the passage of the illuminating radiation is allowed. The shutter may be controllably operable to switch between these states.

The apparatus may be configured to define a radiation propagation scheme for the illuminating radiation in the shuttable optical pass, the radiation propagation scheme includes at least one diffusive reflection or scattering of the illuminating radiation in this pass.

The apparatus may include a radiation source accommodated in the auxiliary chamber. The radiation source may be configured and operable for generating illuminating radiation at wavelength(s) included in a range of wavelengths from 8 to 12 microns; or, alternatively, at a range of wavelengths intersecting with the latter range of wavelengths from 8 to 12 microns; or, alternatively, at a range of wavelengths containing the range of wavelengths from 8 to 12 microns.

The apparatus may be configured to define a radiation propagation scheme for the portion of the illuminating radiation reaching the region (the sample and reference containing region), such that the radiation propagation scheme will include at least one diffusive reflection of this radiation in the second chamber before it reaches the region.

In some of the preferred embodiments, the apparatus includes a baffle accommodated in the main chamber. The baffle may prevent direct illumination of the region by the illuminating radiation.

The apparatus may include means for controllably changing at least one of a position and an orientation of the sample.

The apparatus may include a tangible medium carrying a record of a software product preprogrammed for processing image data indicative of intensity distribution of electromagnetic radiation. The software product may be adapted for calculating the intensity distribution of electromagnetic radiation and/or at least one another parameter related to the optical property of the sample. The at least one another parameter related to the optical property of the sample may be selected from the following: emissivity of the sample; reflectivity of the sample; an intensity of radiation propagating from a sample to the imager; an intensity of radiation propagating from the reference surface to the imager. The software product may be configured for calculating the directional emissivity of the sample εₛ utilizing a formula

$$\frac{1 - {ɛ}_{s}}{1 - {ɛ}_{r}} = \frac{{{i}_{s}}^{( 1 )} - {{i}_{s}}^{( 2 )}}{{{i}_{r}}^{( 1 )} - {{i}_{r}}^{( 2 )}} ,$$

wherein εᵣ is the certain value of the directional emissivity of the reference surface, iₛ⁽¹⁾ and iₛ⁽²⁾ are, respectively, first and second intensities of radiation propagating from the sample to the imager in cases of a first and a second amounts of radiation reaching the region, iᵣ⁽¹⁾ and iᵣ⁽²⁾ are, respectively, first and second intensities of radiation propagating from the reference surface to the imager in the cases of the first and the second amounts of radiation reaching the region.

The apparatus may include a set of the reference units, and the set may define a set of reference surfaces at least two of which are of different shapes.

The apparatus may include an imager synchronized with the shutter.

The apparatus may include a filter in the shuttable optical pass. The filter may pass substantially a spectral band of electromagnetic radiation in which the optical property is to be detected (e.g. the range from 8 to 12 μm, or at which the camera is operative).

In some embodiments, the reflectivity of the main chamber inner surface is larger than 0.8. In some other embodiments, this reflectivity is larger than 0.85, 0.90, or 0.95. The reflectivity may be of this kind only in the spectral band of electromagnetic radiation in which the optical property is to be detected. In some embodiments, a certain part (e.g. major part) of radiation incident on the main chamber inner surface and reflected from this surface is diffusively reflected.

In some of the embodiments, an angular intensity of radiation incident on the region to be imaged (the sample and reference containing region) varies around its average (mean) with a standard deviation not more than 10% of this average. In some other embodiments, this standard deviation is smaller than 8%, or 6%, or 4%, or 2% of the angular intensity mean.

According to yet another broad aspect of the invention, there is provided a method for measuring an optical property of a sample, the method including imaging a region including the sample and a reference surface of a certain value of the optical property while screening the region from external radiation, the imaging including selectively irradiating the region with radiation of a relatively lower and a relatively higher intensity, thereby allowing to obtain image data indicative of intensity distribution of electromagnetic radiation.

As indicated above, the optical property may be at least one of emissivity of the sample, and reflectivity of the sample. The electromagnetic radiation may be at wavelength(s) included in a range of wavelengths from 8 to 12 microns; or, alternatively, may be at a range of wavelengths intersecting with the latter range of wavelengths from 8 to 12 microns; or, alternatively, may be at a range of wavelengths containing the range of wavelengths from 8 to 12 microns. The imaging may be performed with an imager focused on the region.

The method may include analyzing the obtained image data so as to obtain the distribution of intensity of the imaged electromagnetic radiation and/or at least one another parameter related to the optical property of the sample.

The method may include calculating the directional emissivity of the sample εₛ utilizing a formula

$$\frac{1 - {ɛ}_{s}}{1 - {ɛ}_{r}} = \frac{{{i}_{s}}^{( 1 )} - {{i}_{s}}^{( 2 )}}{{{i}_{r}}^{( 1 )} - {{i}_{r}}^{( 2 )}} ,$$

wherein εᵣ is the certain value of the directional emissivity of the reference surface, iₛ⁽¹⁾ and iₛ⁽²⁾ are, respectively, first and second intensities of radiation propagating from the sample to the imager in cases of a first and a second amounts of radiation reaching the region, iᵣ⁽¹⁾ and iᵣ⁽²⁾ are, respectively, first and second intensities of radiation propagating from the reference surface to the imager in the cases of the first and the second amounts of radiation reaching the region.

The may include selecting the reference surface from a set of reference surfaces defined by a set of reference units so as to utilize the certain value of the directional emissivity of the reference surface minimizing an estimate of the error in the optical property of the sample.

According to yet another broad aspect of the invention, there is provided a reference unit for use in optical measurements of an optical property. The unit may be configured to define at least two real surfaces of different shapes covered with materials substantially of the same directional emissivity, and a third virtual surface being defined by the second surface, the directional emissivity of the first surface and the directional emissivity of the third surface being in a predetermined relationship indicative of reflection of light from the first and third surfaces. The reference unit may be useful for measurements of such optical property as at least one of: a directional emissivity of the sample; an emissivity of the sample; and/or a directional hemispherical reflectivity of the sample; a reflectivity of the sample.

The first surface of the reference unit may be planar. The second surface may be an inner surface of a cylindrical cavity. The third surface may be a cross-section of the cylindrical cavity.

The first and second surfaces of the reference unit may be covered with the same material. The first surface may be a virtual surface of a cavity. The second surface may be an inner surface of a square cross-section cavity.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 is an example of an apparatus of the present invention configured for measuring an optical property (e.g. emissivity or reflectivity) of a sample;

FIG. 2 shows a specific but not limiting example of a reference unit for use in optical measurements of an optical property of a sample and a reference;

FIG. 3 shows a relation between the cavity emissivity and its surface emissivity (cavity material emissivity) for a case of cylindrical cavity;

FIG. 4 shows an example of transformation applied to the relation of FIG. 3, graphs G₁-G₃ corresponding to dependency of the ratio of cavity reflectivity to cavity material reflectivity on the cavity material reflectivity, graphs G₁-G₃ corresponding to the ratios of the cylinder depth to the cylinder radius of values 2, 4 and 6, respectively;

FIG. 5 shows an experimental setup of the invented apparatus;

FIG. 6 shows more specifically a region of an optical window including a shutter plate, in the apparatus of FIG. 6;

FIG. 7 shows a drawing of the sample and reference holder in the apparatus of FIG. 6;

FIG. 8 shows a drawing of the sample and reference holder carrying a sample and a reference unit, in the apparatus of FIG. 6;

FIGS. 9A and 9B are drawings of two exemplary reference units used in the experiments;

FIG. 10 shows a drawing of a typical image obtained by an imager focused at the reference and sample containing region;

FIG. 11 illustrates a screen of a control system used for the image data analysis;

FIGS. 12A and 12B present graphs of the apparent temperatures for various surfaces.

### DETAILED DESCRIPTION OF EXEMPLARY EMBODIMENTS

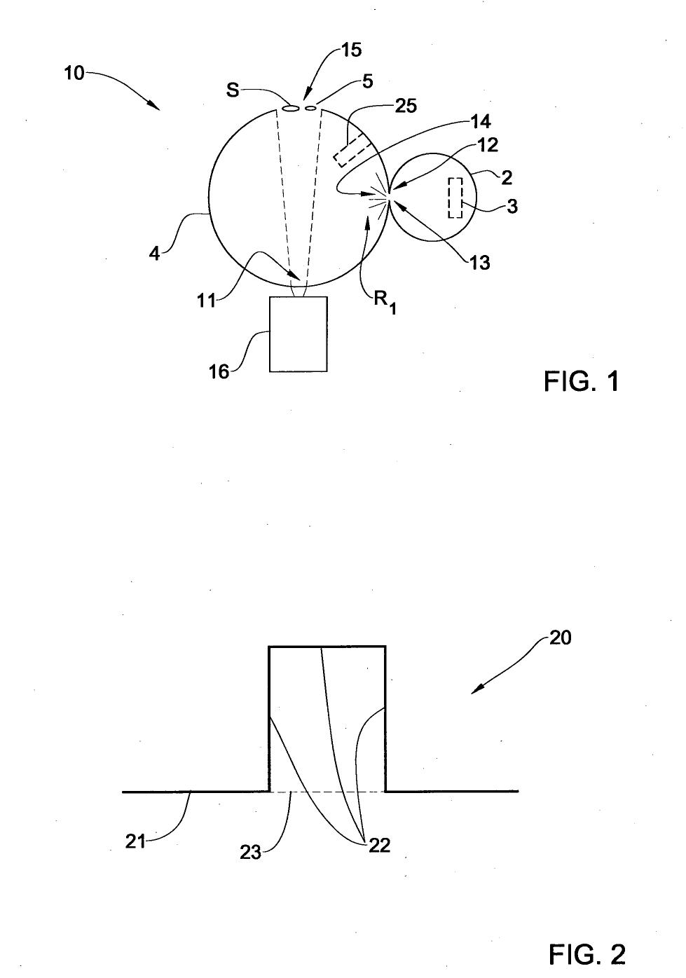

In reference to FIG. 1, there is illustrated an example of an apparatus 10 of the present invention. Apparatus 10 is configured for measuring an optical property, e.g. emissivity, reflectivity or absorbance, of a sample S. Apparatus 10 includes a reference unit 5 presenting a certain value of the optical property; a first chamber 4, also called main chamber or sphere; and a second chamber 2, also called auxiliary chamber or sphere. Chambers 2 and 4 define optical windows 12 and 14, respectively, allowing passage of electromagnetic radiation therethrough. Windows 12 and 14 and therefore first and second chambers 4 and 2 are connected by a shuttable optical pass 13 allowing controllable passage of illuminating radiation from the auxiliary chamber through its optical window into the main chamber through its optical window. Main chamber 4 is configured to define a region 15 thereof (e.g. a port) for accommodating reference unit 5 and sample S, and is configured to screen this region from external radiation. Apparatus 10 is configured to direct a portion of illuminating radiation Rᵢ, reflected from main chamber inner surface, to region 15.

Optionally, the main chamber includes a baffle 25, positioned and oriented so as to prevent direct illumination of region 15 by radiation Rᵢ. The presence of baffle 25 can allow diffusing a larger portion of radiation Rᵢ. With a baffle, inner surface of chamber 4 can not be spherical, but can remain mostly spherical.

Apparatus 10 can be used as in the following example. An imager 16, which may be or may be not a constructional part of apparatus 10, is accommodated so as to have the reference and sample containing region 15 in its field of view. In the present example, imager 16 is an infrared camera positioned outside main chamber 4; it images region 15 through an optical window 11 appropriately provided in chamber 4. Imaging region 15 contains reference unit 5 placed next to sample S; the reference unit is oriented so that its surface of the certain optical property (i.e. its reference surface) is exposed to camera 16. Camera 16 receives radiance coming from the sample surface and at least one reference surface. By using a camera with an appropriate resolution, concurrent imaging of the reference unit and the sample is enabled. While the sample and the reference surfaces are located one beside another they are illuminated by background radiation of the same intensity.

For measurement of the normal emissivity of the sample, two images of the reference unit and the sample can be taken with different background conditions. Obtaining different background conditions can be enabled for example by accommodating a radiation source 3 into chamber 2 to produce illuminating radiation Rᵢ in chamber 2 and by shutting optical pass 13, thus changing amount of illuminating radiation Rᵢ entering chamber 4 from chamber 2. Radiation source 3 may or may not be a constructional part of apparatus 10.

Preferably, but not necessarily, a change in the background conditions is a step change, i.e. rapid shutting takes place. Preferably, but not necessarily, increasing or decreasing the amount of background radiation for a time causes no substantial change in the reference unit and the sample temperature.

Radiation leaving a surface and detected by a camera can be presented in the following forms:

$$\begin{matrix}{i}_{{λ}_{1} - {λ}_{2}}^{D} = \frac{σ ( {T}_{app} )}{π} {F}_{{T}_{app} , {λ}_{1} - {λ}_{2}} \\ = {ɛ}_{{λ}_{1} - {λ}_{2}}^{D} \frac{{σ ( {T}_{real} )}^{4}}{π} {F}_{{T}_{real} , {λ}_{1} - {λ}_{2}} + {ρ}_{{λ}_{1} - {λ}_{2}}^{h , D} {i}_{B , {λ}_{1} - {λ}_{2}}^{h} ,\end{matrix} \qquad \text{(D-1)}$$

where:
i_{λ}_{₁}_{-λ}_{₂}^{D} is the intensity of the radiation leaving the surface under a certain background condition and then received by the camera, in a wavelength region from λ₁ to λ₂ (i.e. λ₁-λ₂);
σ is the Stefan-Boltzmann constant [W/m²K⁴];
Tₐₚₚ is an apparent temperature of the surface, i.e. a temperature that would be assigned to a surface by a camera user assuming that all radiation received by the camera is due to emission;
Tᵣₑₐₗ is a real surface temperature;
F_{T,λ}_{₁}_{-λ}_{₂} is a fraction of total blackbody intensity or emissive power lying in spectral region λ₁-λ₂ at a temperature T, such as the apparent surface temperature Tₐₚₚ or the real surface temperature Tᵣₑₐₗ;
i_{B,λ}_{₁}_{-λ}_{₂}^{h} is an intensity of background radiation incident on the surface from the hemisphere it faces;

If the case is such that a camera efficiency is smaller than 1, (D-1) can be easily amended to account for the smaller measured intensity.

When a substitute of the reflectivity ρ^{hD} by a term ρ^{dh}=(1−ε^{D}) is made, the formula for the camera reading becomes:

$${i}_{{λ}_{1} - {λ}_{2}}^{D} = {ɛ}_{{λ}_{1} {λ}_{2}}^{D} \cdot \frac{{σ ( {T}_{real} )}^{4}}{π} {F}_{{T}_{real} , {λ}_{1} - {λ}_{2}} + ( 1 - {ɛ}_{{λ}_{1} - {λ}_{2}}^{D} ) \cdot {i}_{B , {λ}_{1} - {λ}_{2}}^{h} \cdot \qquad \text{(D-2)}$$

If the background radiation is relatively diffusive and the surface is opaque, the substitute leading to (D-2) is enabled.

In the case when two measurements are made, the equations for the radiation leaving, respectively, the sample and the reference surfaces in the first measurement are:

$$\begin{matrix}{i}_{s}^{( 1 )} = {ɛ}_{s} \frac{{σ ( {T}_{s}^{( 1 )} )}^{4}}{π} {F}_{{T}_{s}^{( 1 )} , {λ}_{1} - {λ}_{2}} + ( 1 - {ɛ}_{s} ) {i}_{B , {λ}_{1} - {λ}_{2}}^{( 1 )} . & \text{(D-3)} \\ {i}_{r}^{( 1 )} = {ɛ}_{r} \frac{{σ ( {T}_{r}^{( 1 )} )}^{4}}{π} {F}_{{T}_{r}^{( 1 )} , {λ}_{1} - {λ}_{2}} + ( 1 - {ɛ}_{r} ) {i}_{B , {λ}_{1} - {λ}_{2}}^{( 1 )} . & \text{(D-4)}\end{matrix}$$

Subscripts s and r and are used to denote parameters related to the sample and to the reference, respectively. The superscript D and superscript λ₁-λ₂ where appropriate (in the measured intensity and emissivity), are implied.

Similarly, the equations for the radiation leaving the sample and the reference surfaces in the second measurement are:

$$\begin{matrix}{i}_{s}^{( 2 )} = {ɛ}_{s} \frac{{σ ( {T}_{s}^{( 1 )} )}^{4}}{π} {F}_{{T}_{s}^{( 1 )} , {λ}_{1} - {λ}_{2}} + ( 1 - {ɛ}_{s} ) {i}_{B , {λ}_{1} - {λ}_{2}}^{( 2 )} & \text{(D-5)} \\ {i}_{r}^{( 2 )} = {ɛ}_{r} \frac{{σ ( {T}_{r}^{( 1 )} )}^{4}}{π} {F}_{{T}_{r}^{( 1 )} , {λ}_{1} - {λ}_{2}} + ( 1 - {ɛ}_{r} ) {i}_{B , {λ}_{1} - {λ}_{2}}^{( 2 )} & \text{(D-6)}\end{matrix}$$

In (D-5) and (D-6) superscript (2) signifies that the background conditions in the second measurement are different from the first measurement. However, it is assumed that the temperatures of the reference and the sample surfaces did not change in a time frame between the two measurements.

Subtracting (D-3) from (D-5), and (D-4) from (D-6) yields:

iₛ⁽²⁾−iₛ⁽¹⁾=(1−εₛ)Δi_{B,λ}_{₁}_{-λ}_{₂}, (D-7)

iᵣ⁽²⁾−iᵣ⁽¹⁾=(1−εᵣ)Δi_{B,λ}_{₁}_{-λ}_{₂}. (D-8)

where Δi_{B,λ}_{₁}_{-λ}_{₂}=i_{B,λ}_{₁}_{-λ}_{₂}⁽²⁾−i_{B,λ}_{₁}_{-λ}_{₂}⁽¹⁾

Dividing (D-7) by (D-8) yields:

$$\frac{{i}_{s}^{( 1 )} - {i}_{s}^{( 2 )}}{{i}_{r}^{( 1 )} - {i}_{r}^{( 2 )}} = \frac{1 - {ɛ}_{s}}{1 - {ɛ}_{r}} \cdot \qquad \text{(D-9)}$$

The sample emissivity is thus given by the equation:

$${ɛ}_{s} = 1 - \frac{{i}_{s}^{( 1 )} - {i}_{s}^{( 2 )}}{{i}_{r}^{( 1 )} - {i}_{r}^{( 2 )}} {ρ}_{r} = 1 - \frac{Δ {i}_{s}}{Δ {i}_{r}} {ρ}_{r} \qquad \text{(D-10)}$$

Here by ρᵣ a directional reflectivity ρᵣ^{-D,h}, corresponding through (B-6) to the respective directional emissivity participating in (D-10), is meant.

As it has been mentioned above, the camera measurement can be reported as a map of apparent temperatures Tₐₚₚ. In such case (D-1) can be used to obtain any of intensities iᵣ⁽ⁱ⁾ and iₛ⁽ⁱ⁾ as a spatial average of the term σ(Tₐₚₚ)⁴F_{T}_{_{apρ}}_{,λ}_{₁}_{-λ}_{₂}/π, this spatial average being respectively calculated at pixels imaging the reference and the sample for each of the two measurements (i).

Also, according to (D-9) or (D-10) the accuracy of the measurement of the emissivity of a sample depends on the accuracy of the certain emissivity or reflectivity of the reference surface. The certain emissivity εᵣ or certain reflectivity ρᵣ of the reference surface can be predetermined or can be measured.

In the above described procedure of measuring the emissivity of the sample, apparatus 10 is configured to direct a portion of illuminating radiation Rᵢ to the reference and sample containing region 15 in chamber 4. In a preferred embodiment, inner surface of chamber 4 reflects a portion of illuminating radiation Rᵢ and by diffusing it towards region 15. To this end inner surface of chamber 4 is made diffusively reflective at least for its most part. In such a configuration chamber 4 can be regarded as an integrating chamber, or as an integrating sphere if the chamber's inner surface is mostly spherical.

Additionally, illuminating radiation Rᵢ can be diffused before it comes from optical window 14 into chamber 4. The latter can be done for example by diffusively reflecting radiation Rᵢ from inner surface of chamber 2 and/or by accommodating a diffuser somewhere in optical pass 13.

By using the above described apparatus 10 any directional emissivity (e.g. a normal emissivity) of the sample surface can be measured by accordingly adjusting the angle (D) of orientation of the sample surface in respect to the optical axis of the camera plane. To this end, means for controllably changing the orientation of the sample can be included in apparatus 10.

With regards to the certain emissivity εᵣ presented by the reference unit, it can be obtained by several ways. In some embodiments, the certain emissivity εᵣ is predetermined. The surface of such reference unit may be planar or may define a cavity. In other embodiments, emissivity εᵣ is measured with apparatus 10, for example together with a measurement of an optical property of a sample.

Reference is made to FIG. 2 exemplifying a reference unit configuration 20 for use in optical measurements of an optical property of a sample. Reference unit 20 defines three surfaces 21, 22 and 23. Plain surface 21 and cavity inner surface 22 are real diffuse surfaces made of the same material. Plane surface 23 is virtual surface. It can be imaged by camera. Ratio of energy passing through it to energy emitted by black body disk of the same radius is an apparent emissivity of cavity. Considering the use of reference unit 20 in apparatus 10, these surfaces 21 and 22 include the same diffuse materials or materials of substantially the same reflectivity to be exposed to the illuminating radiation.

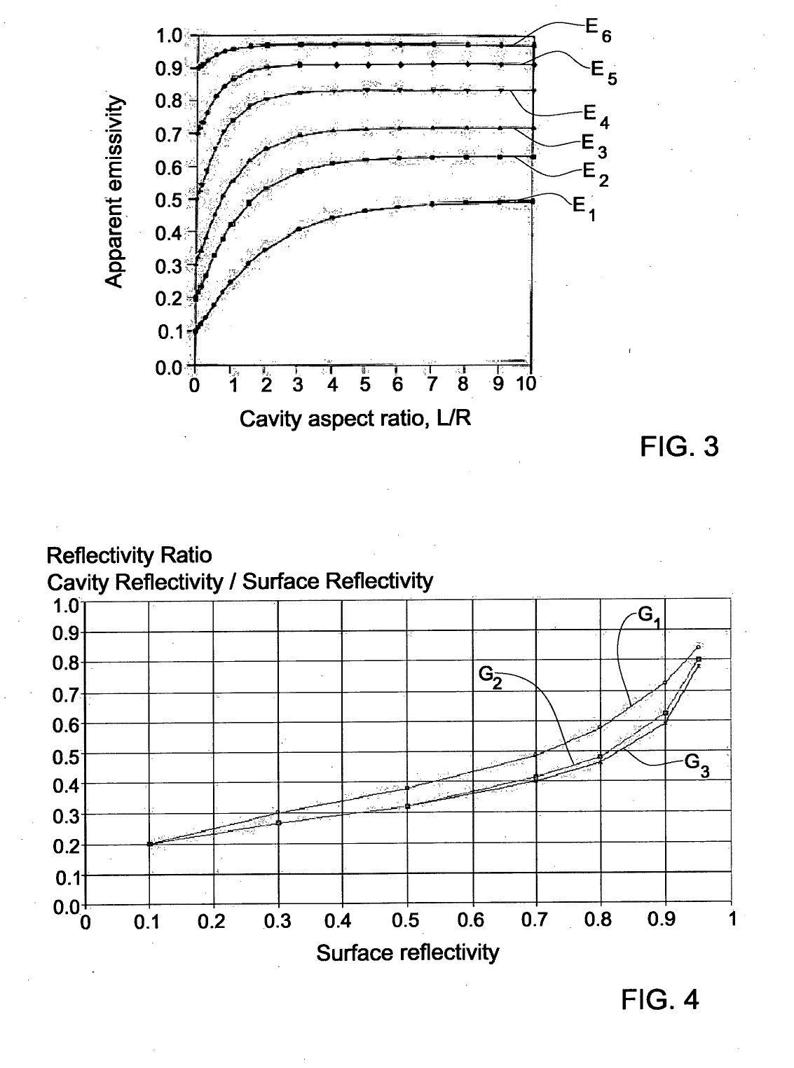

It was shown in [11, 12] that the apparent emissivity of a cavity, e.g. of a cylindrical cavity defined by surface 22, relates to the emissivity of the material of the cavity surface. The cavity apparent emissivity can be calculated from the cavity geometry or shape. FIG. 3 shows a predetermined relation between the cavity apparent emissivity and its surface emissivity (cavity material emissivity). In the example of FIG. 3 a case of cylindrical cavity is considered. There, the horizontal axis is a ratio of the cylinder depth to the cylinder radius, and the vertical axis is the apparent emissivity of the cavity. Graphs ε₁-ε₆ correspond to values 0.1, 0.2, 0.3, 0.5, 0.7 and 0.9, respectively, of the cavity material emissivity. These graphs are based on the cavity theory [11, 12]. Graphs ε₁-ε₆ were calculated using an assumption that the cavity inner surface is diffusive, gray in the wavelength range of the measurement, and its temperature is uniform.

A relation between the cavity apparent emissivity, the cavity material emissivity and cavity geometry can be transformed into a relation between a ratio of cavity apparent reflectivity to cavity material reflectivity, cavity material reflectivity, and cavity geometry. An example of the latter relation, obtained by such transformation applied to the relation of FIG. 3 for diffuse surfaces, is illustrated in FIG. 4. There, graphs G₁-G₃ of dependency of the ratio of apparent cavity reflectivity to cavity material reflectivity on the cavity material reflectivity are shown; graphs G₁-G₃ correspond to the ratios of the cylinder depth to the cylinder radius of values 2, 4 and 6, respectively.

Using the relation between such three values as the ratio of cavity apparent reflectivity to cavity material reflectivity, cavity material reflectivity and cavity geometry, the cavity material reflectivity can be found by a measurement. To this end, (D-9) is rewritten to apply to surfaces 21 and 23 so as to allow for calculating reflectivity ratio for these two surfaces:

$$\frac{{ρ}_{23}}{{ρ}_{21}} = \frac{( 1 - {ɛ}_{23} )}{( 1 - {ɛ}_{21} )} = \frac{{i}_{23}^{( 1 )} - {i}_{23}^{( 2 )}}{{i}_{21}^{( 1 )} - {i}_{21}^{( 2 )}} = \frac{Δ {i}_{23}}{Δ {i}_{21}} \qquad \text{(D-11)}$$

In (D-11) terms ε₂₁ and ε₂₃ are emissivities and terms ρ₂₁=(1−ε₂₁) and ρ₂₃=(1−ε₂₃) are reflectivities of surfaces 21 and 23, respectively; i₂₁⁽¹⁾ and i₂₁⁽²⁾ are average intensities of radiation, reaching an imager during first and second measurements from surface 21; i_{D,23}⁽¹⁾ and i_{D,23}⁽²⁾ are average intensities of radiation reaching the imager during the first and second measurements from surface 23. The measurements differ in the amount of illuminating radiation. The geometry of surfaces 21 and 22 and of the cavity is known or can be measured, and thus both reflectivities ρ₂₁ and ρ₂₃ can be found using (D-11) and functional dependencies examples of which are shown in FIG. 4. Either reflectivity ρ₂₁ and ρ₂₃ can be used as a reference surface reflectivity ρᵣ.

As a result, determination of the sample emissivity εₛ can be done from equation (D-10) using the obtained value of ρᵣ.

It should be noted, that one or two measurements needed for determining the sample emissivity εₛ by using (D-10) (or (D-9)) can be done concurrently or separately with one or two measurements needed for determining the reference emissivity εᵣ by using (D-11). For example, taking measurements for determining the reference emissivity εᵣ and for determining the sample emissivity εₛ simultaneously can decrease that error in the emissivity εₛ which is due to time variation in the reference emissivity εᵣ.

An error in the sample optical property (e.g. emissivity εₛ) can be estimated. This error relates to a measurement error of a reference optical property, e.g. an error δρᵣ in the reference reflectivity ρᵣ. The latter error is proportional to the error

$$δ ( \frac{{ρ}_{23}}{{ρ}_{21}} )$$

of the ratio

$$\frac{{ρ}_{23}}{{ρ}_{21}} : {δρ}_{r} = K δ ( \frac{{ρ}_{23}}{{ρ}_{21}} ) ,$$

where K is a coefficient calculated from the black body theory. For example, for references with reflectivity more than 0.8 the coefficient K is less than 1. A relative measurement error in the reference surface reflectivity can be presented as:

$$\frac{{δρ}_{r}}{{ρ}_{r}} \approx K \sqrt{{( \frac{δ i}{Δ {i}_{21}} )}^{2} + {( \frac{δ i}{Δ {i}_{23}} )}^{2}} \qquad \text{(D-12)}$$

Here δi is a camera intensity resolution, which can be calculated using the camera temperature resolution δT. In the experiments conducted by the inventors this temperature resolution was about 0.03° C. A useful conclusion follows from (D-12): more accurate values for reference reflectivity may be obtained using a reference block (unit) with high reflectivity of working surfaces 21 and 22 and a cavity with smaller ratio L/r that lead to increasing intensity jumps Δi_{D,21} and Δi_{D,23}.

As a result, the measurement error of the sample reflectivity and emissivity can be estimated by formulas obtained from (D-10):

$$\begin{matrix}\frac{{δρ}_{s}}{{ρ}_{s}} = \sqrt{{( \frac{δ i}{Δ {i}_{s}} )}^{2} + {( \frac{δ i}{Δ {i}_{r}} )}^{2} + {( \frac{δ {ρ}_{r}}{{ρ}_{r}} )}^{2}} & \text{(D-13)} \\ \frac{{δɛ}_{s}}{{ɛ}_{s}} = \frac{{ρ}_{s}}{{ɛ}_{s}} \frac{{δρ}_{s}}{{ρ}_{s}} & \text{(D-14)}\end{matrix}$$

Also, errors in a sample optical property can be due to a change in the absolute temperature of the surfaces between the measurements and, in the case of a presence of directional effects, to non-diffuse background.

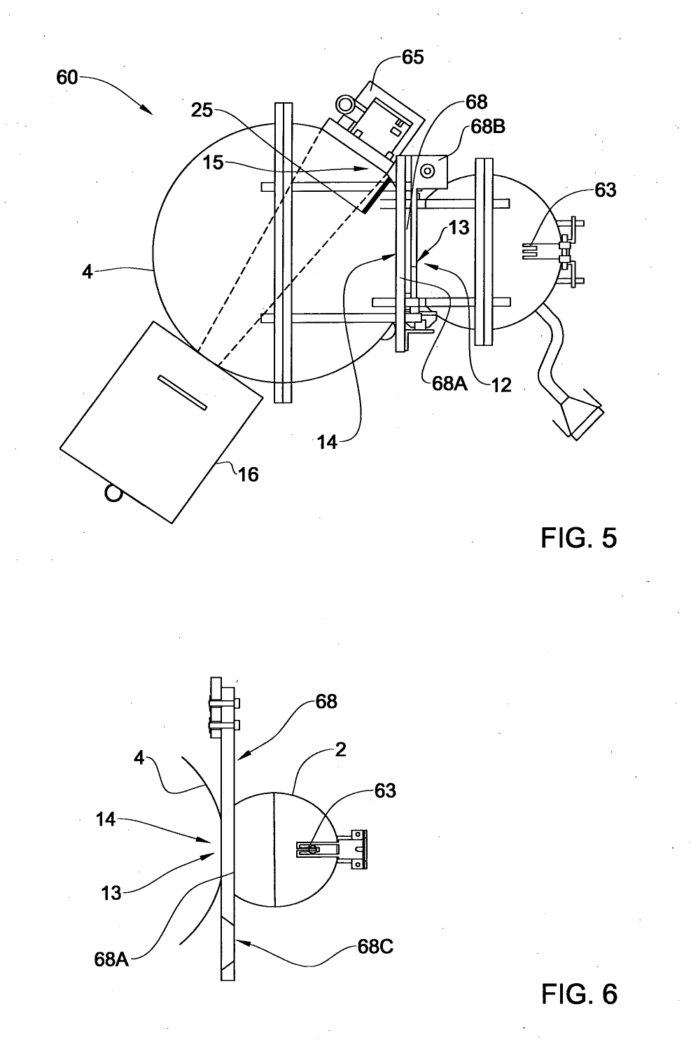

FIG. 5 schematically shows an experimental setup of an apparatus 60 used by the inventors. Apparatus 60, in additional to components numbered in FIGS. 1 and 2, includes a sample and reference holder 61, an emitter 63, and a shutter 68 including a shutter plate 68A and a shutter plate motor 68B.

Main chamber 4 and auxiliary chamber 2 are mostly spherical inside. They are made of cast aluminum, each of them had two separable hemispherical halves allowing chambers to be relatively easily opened and closed (the hemispheres and their connectors are recognizable in the illustration and are shown without reference numbers). Chambers' inner walls were sand blasted and then coated with 24K gold. By the sand blasting diffusive surfaces were created. The gold coating thickness was in a range of 2-4 μm. Such a coating kept the wall roughness.

Baffle 25 was a circular disk, which prevented direct radiance from optical window 13 onto the sample and the reference surfaces. The baffle faces were blasted and coated as the chambers' inner walls.

Imager 16 used by the inventors in the experiments was a “Thermo Tracer NEC 5102” camera. The images were taken at the wavelength range of 8-12 μm. Each pixel of camera 16 imaged an area of 0.658×0.71 mm² of region 15, according to the geometrical dimensions of apparatus 60. The focal length of the camera could be maintained by the camera controls, so as to enable reproducibility of measurements. In the experiments conducted by the inventors, the focal length value was programmed to the focal length of 0.37 m.

In some preferred embodiments, the imager (camera) is synchronized with the shutter operation. In some embodiments, the imaging rate is faster than ⅔ sec.

Emitter 63 was a silicon-carbide heating element with maximal power consumption of 460 W at 115 Vac. The emitter was placed in the back of auxiliary sphere 2 opposite to the optical window 13 between spheres 4 and 2. Emitter 63 had no direct contact with the sphere body and the main mechanism of the heat transfer was by radiation. Air-cooling was added to the inner cavity of auxiliary sphere 2 to prevent heating of the sphere body and damage to the gold coating.

Shutter 68 is an aluminum plate 68A connected to a pneumatic cylinder 68B. Shutter plate 68A can be in two positions. At the open position, main sphere 4 is connected to auxiliary sphere 2 through optical window 13, through a port cut in shutter plate 68A. At the closed position, spheres 4 and 2 are disconnected with shutter plate 68A. The port size enabled high enough transfer of radiation from auxiliary sphere 2 to main sphere 4, while being small enough so that chambers 4 and 2 were mostly spherical.

In parallel to the shutter, an optical filter (not shown) between the two chambers may be mounted. The filter may be configured for allowing passage of radiation only in the wavelength range selected for the measurements, e.g. radiation between 8-12 μm. Such a filter can minimize excessive heating of the sample(s).

In FIG. 6, a region of optical window 13 including shutter plate 68A is shown more specifically. The shutter plate is shown to have a shutter port 68C being an optical window permitting light transmission through a region of the shutter plate. In this example shutter 68 is in the state in which optical window 13 is closed.

Also, the shutter can be configured as an aperture adjuster. The shutter can be made without moving parts. In particular, it may be operative to change its transmitting properties, i.e. to pass less or more radiation, or to deflect radiation from the main chamber, so as to change background radiation illumination within the main chamber. Therefore, the shutter may be controlled by a control signal. Particularly, the shutter may be a tunable filter.

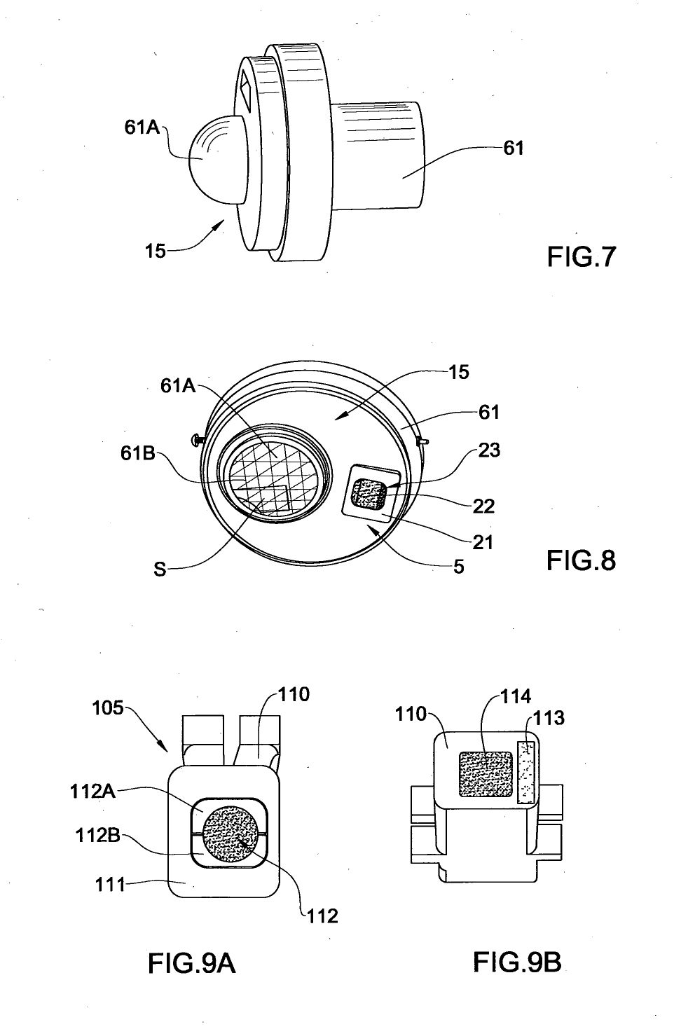

In reference to FIG. 7 there is shown a sketch of the sample and reference holder 61. The latter has a rotatable sample carrier 61A. On the sketch, sample carrier 61A is a disk that can rotate around two axes, one axis being directed along the camera line of sight, and the other axis being normal to the camera line of sight while being in the plane of reference holder's region 15 which is to be imaged by the camera. The orientation of sample carrier 61A in respect to these two axes is defined by two angles, θ and φ, respectively. Rotating a sample carried by the sample carrier facilitates measuring the directional emissivity εₛ(φ, θ) of the sample surface.

In reference to FIG. 8 there is shown a sketch of the sample and reference holder 61 carrying a sample S and a reference unit 5. The latter includes reference surfaces 21 and 22. Sample S is held on sample carrier 61A at a distance of 2 mm from the disk surface by a nylon net 61B. Those surfaces of sample carrier 61A and the sample and reference holder 61 that face the inner cavity of the main chamber were sand blasted and gold coated as it was done with the chambers walls. That ensured having substantially diffuse radiation in chambers illuminating region 15.

With reference to FIGS. 9A and 9B, there are shown sketches of two embodiments of the reference unit used in the experiments. In FIG. 9A reference unit 105 is a stainless steel block 110 with a cavity 112 defined by inner surfaces of two semi-cylinders 112A and 112B inserted into a larger square cavity 114 in block 110. The depth of cavity 112 is determined by the position of the bottoms of the semi-cylinders and can be varied. A reference surface 111 formed by a surface of block 110 and surfaces of semi-cylinders 112A and 112B had an inclination of 5° so as to enable convenient orienting this surface perpendicular to the line of sight of the camera.

In FIG. 9B the square cavity 114 of the block 110 is lined by a diffusive aluminum foil. A piece of the diffusive aluminum foil was also attached to the surface of block 110; a surface 113 of this piece was used as a reference surface.

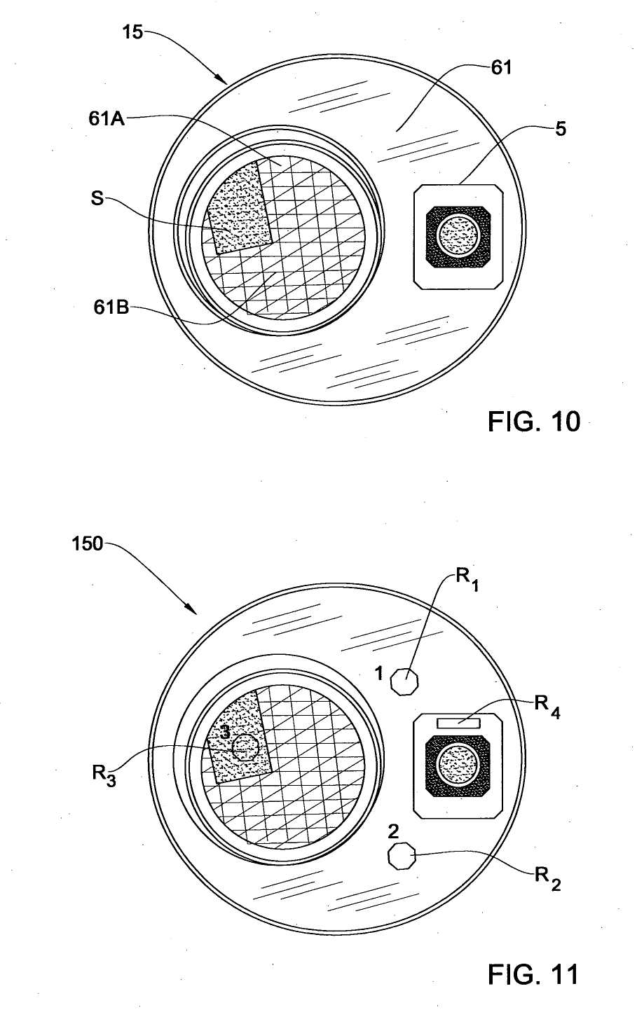

FIG. 10 shows a sketch of a typical image obtained by imager 16, in this case camera focused at region 15 containing a sample S and a reference unit 5. The reference unit defines reference surfaces 21 and 23, the latter being defined by a cavity made in the reference unit. Other objects seen in FIG. 10 include sample and reference holder 61, sample carrier 61A, nylon net 61B (nylon net threads correspond to thin lines in FIG. 10).

The camera produced images containing 255×223 pixels. Each pixel returned an apparent temperature value, representing the power arriving from some area on the imaged region.

In FIG. 11 there is shown a sketch of a screen 150 of a control system (typically a computer system) used for the image data analysis. Computer screen 150 presents the image data, obtained from the camera, to a user. The computer allowed selecting regions (measuring points or areas, MDEFs) in the screen and analyzing them so as to calculate e.g. minimum, maximum and average apparent temperatures based on all pixels enclosed in such a selected region. In computer screen 150 regions R1, R2, R3, R4 were selected. It is seen that regions R1 and R2 in the image correspond to regions on the sample carrier (having a surface covered by gold), region R3 corresponds to a region of the sample (having a white paper surface), region R4 corresponds to a region of the reference unit (having a stainless steel surface).

The measurements were executed for the selected regions by taking one or more images. In some cases, times when the images were taken were recorded. That allowed obtaining the apparent temperatures as functions of time.

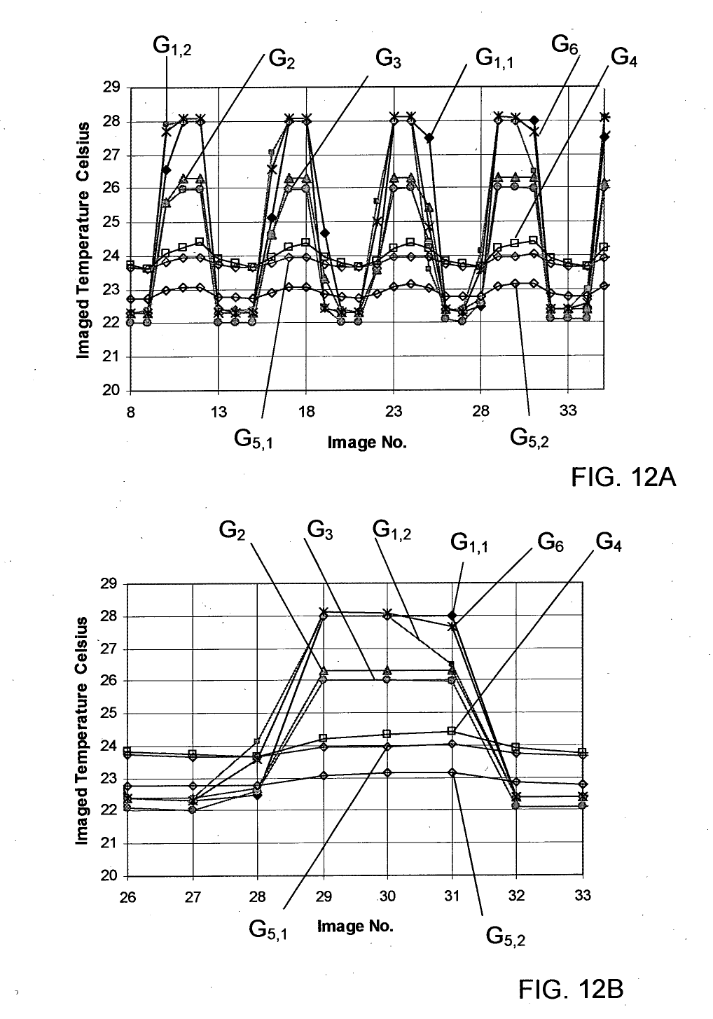

In FIGS. 12A and 12B (the latter is a close-up of the former) eight graphs G_{1,1}, G_{1,2}, G₂-G₄, G_{5,1}, G_{5,2}, G₆, each corresponding to an apparent temperature dependency on time for one of eight different surfaces, are shown. The surfaces included: two gold surfaces (graphs G_{1,1} and G_{1,2}), a steel surface (graph G₂), a virtual surface of a cylindrical cavity having walls of aluminum foil (graph G₃), a surface of a piece of paper (graph G₄), two leaves' surfaces (graphs G_{5,1} and G_{5,2}), and a surface of an aluminum foil such as used for the cavity walls (graph G₆). Typical measurements results obtained from a sequence of images are shown. The apparent temperatures were calculated as averages of apparent temperatures of measurement regions defined on the measured surfaces. The oscillating-like changes in the apparent surfaces' temperatures were due to the cycled operation of the shutter: the apparent temperature increased when the shutter was opened and decreased when the shutter was closed. The variations between the amplitudes of these changes were due to the different emissivity of the surfaces. For high emissivity (low reflectivity) surfaces, e.g. the paper and leaves surfaces, the amplitude oscillation in the apparent temperature is less than that for low emissivity (high reflectivity) surfaces, e.g. the golden and aluminum foil surface.

If a measurement of an optical property relies on thermal images taken while the shutter was opening or closing, such a measurement yields an apparent temperature being less than the apparent temperature highest value, and therefore typically larger error in the optical property. Hence, in some preferred embodiments, imaging provides measurements with the shutter being completely open and with the shutter being completely closed. This way a higher difference between the background conditions and a higher accuracy of measurement can be achieved. Moreover, in some embodiments, the apparent temperature measurement results from the background radiation changed as a square-like wave.

In some cases, real temperatures of imaged surfaces significantly change in response to a change in background radiation. For instance, this is observed for the paper and the leaves in FIGS. 12A and 12B: their apparent temperatures change (grow) while the background radiation is constant. The changes are associated with the heating of the paper and leaves surfaces. In some preferred embodiments, a camera imaging rate and a shutter switching time are selected so as to allow taking a sufficient number of measurements, but to substantially prevent surfaces heating.

In some embodiments, the effect of the increase of real temperature with increase of intensity of background radiation was taken into account in estimation of the optical property. To this end, imaging was performed at more than two points in time. The increase in the real temperature could be estimated using, for example, a change in the apparent temperature in a time interval at which the background radiation was constant: based on this change, a change in the real temperature between the points at which the background radiation was different was approximated (extrapolated), and that portion of the change in the apparent temperature between the points at which the background radiation was different, that was due to reflection, was determined.

It should be noted that the effect of change in the real temperature is stronger for low reflectivity surfaces, e.g. for paper and leaves surfaces, than for metal surfaces, for which the apparent temperatures arrive to steady states shortly after a shutter switching event. There are two main reasons for the difference between the apparent temperature behaviors for metal and paper and leaves surfaces. The first reason is that the paper and leaves absorbance is relatively high, and thus their surfaces receive more heating energy which tends to increase paper and leaves real surface temperatures. The second reason is that the metal thermal conductivity is relatively high while the metal objects are often relatively massive: thus, the same absorbed heat changes the real surface temperature of a metal object less it would do for a paper piece or for a leaf.

The above-described correction procedure for the change in real temperature can be illustrated by FIG. 12B. Judging by the behavior of the apparent temperature of the metals surfaces, it can be concluded that the shutter was completely open when images 29 and 30 were taken. Therefore, the difference between the apparent temperatures of the paper or the leaves surfaces at images 29 and 30 is mostly due to the heating of these surfaces by background radiation. Considering The paper or the leaves surfaces' apparent temperature value at images 27 and 29, the difference between images 27 and 29 is partially due to reflection of the increased background radiation and partially due to the increase in the surface real temperature. Since the latter can be approximated by extrapolation, the former also can be estimated.

Hence, the technique of the invention allowed performing concurrent or simultaneous measurements of the emissivity of all the surfaces appearing in the field of view (FOV) of the camera. The inventors utilized this property of the technique of the invention to measure at once the emissivity of various surfaces. In particular, FIGS. 12A and 12B have been used by the inventors for calculation of emissivity of the respective surfaces. Calculation of the emissivity generally includes two steps: calculation of the reference optical property, and calculation of the sample emissivity. The first step is needed only if the reference optical property is unknown.

An apparatus configuration, used in the conducted experiments, was operated at the following conditions: an emitter supplied radiation of power of 160 W; a camera lens provided 0.37 m of focal length; the configuration included a baffle. The aluminum foil was used as a reference.

For each measurement cycle (shift of shutter between on and off states), a pair of apparent temperatures for each surface (gold, paper etc.) was received. The calculation of the emissivity was done for each pair of apparent temperatures. Where needed, the correction for samples heating or cooling was performed. Then, a statistical processing was applied to calculated samples' emissivity values. Standard deviations and random errors of emissivities were also estimated.

In one embodiment, the reference unit included a cavity which inner surface was covered with aluminum foil, the ratio between the reference and the cavity reflectivities was

$$\frac{{ρ}_{cavity}}{{ρ}_{r}} = 0.682 \pm 0.011 \cdot$$

The performed measurements yielded the reflectivity value ρᵣ=0.921±0.003 for the aluminum foil. According to (D-12) and using data presented in FIG. 12A, the estimation error was estimated as

$$\frac{{δρ}_{r}}{{ρ}_{r}} \approx 0.9 \% \cdot$$

The below table 1 presents the results of the emissivity calculated for these surfaces at these base conditions (the error was estimated using (D-13)):

TABLE 1
Emissivities, measured using the invented apparatus
including the BB reference unit of the invention.

| | | | Stainless | White | Leaf | Leaf |
|---|---|---|---|---|---|---|
| | Gold 1 | Gold 2 | Steel | Paper | Type 1 | Type 2 |
| Average | 0.094 | 0.099 | 0.368 | 0.900 | 0.947 | 0.943 |
| value of ε | | | | | | |
| Average | 0.906 | 0.901 | 0.632 | 0.100 | 0.053 | 0.057 |
| value of ρ | | | | | | |
| Standard | 0.0107 | 0.0116 | 0.0090 | 0.0114 | 0.0077 | 0.0073 |
| deviation | | | | | | |
| error of ε | 10 | 10 | 2 | 0.68 | 0.57 | 0.53 |
| [%] | | | | | | |
| error of ρ | 1 | 1 | 1, 2 | 6.1 | 10.1 | 8.8 |
| [%] | | | | | | |

| | | | | |
|---|---|---|---|---|
| Emissivity | 0.075-0.13 ^{[14]} | 0.3-0.4 ^{[14]} | ~0.9 | ~0.94-0.97 |
| values given | | | | |
| in literature | | | | |

It is seen from the Table 1 that the values obtained from the measurements generally match the values cited in literature. The accuracy of the emissivity calculation depends on three main factors: the accuracy of the reference emissivity, the camera imaging rate (high imaging rate enables to define the moment of the change in the background conditions); and the shutter operating time (fast switching of the shutter allows avoid excessive surface heating).

As it can be seen from Table 1, the apparatus of the invention has allowed measuring the directional sample emissivity. It should be understood, that it means that the technique of the invention enables determining a dependence of the emissivity on the viewing angle. To this end the sample holder may be rotated, either zenithally and/or azimuthally or both, so that the sample surface orientation will change with respect to the camera while the sample receives hemispherical diffuse radiation. The main chamber, and in some of the preferred embodiments, the auxiliary chamber, are therefore the means for diffusing the radiation i.e. for producing the diffuse hemispherical radiation.

Those skilled in the art will readily appreciate that various modifications and changes can be applied to the embodiments of the invention as herein described without departing from its scope defined in and by the appended claims.

1. A kit for use in measuring an optical property of a sample, the kit comprising at least one reference unit, having a reference surface of a directional emissivity of a certain value; and main and auxiliary chambers, each defining an optical window allowing passage of electromagnetic radiation therethrough, the main chamber is configured to define a region thereof for accommodating said reference unit and the sample and is configured to screen this region from external radiation.

2. The kit of claim 1, comprising an imager capable of obtaining image data indicative of intensity distribution of detected electromagnetic radiation.

3. The kit of claim 2, wherein said imager is operative at wavelength(s) included in a range of wavelengths from 8 to 12 microns.

4. The kit of claim 2, wherein said imager is operative at a range of wavelengths intersecting with a range of wavelengths from 8 to 12 microns.

5. The kit of claim 2, wherein said imager is operative at a range of wavelengths containing a range of wavelengths from 8 to 12 microns.

6. The kit of claim 1, comprising a radiation source mountable inside said auxiliary chamber.

7. The kit of claim 6, comprising an imager capable of obtaining image data indicative of intensity distribution of detected electromagnetic radiation, the radiation source and the imager being operative in substantially intersecting wavelength regions of infrared electromagnetic radiation.

8. The kit of claim 7, wherein the radiation source and the imager are operative in substantially the same wavelength region.

9. The kit of claim 7, wherein the radiation source and the imager are operative at wavelength(s) included in a range of wavelengths from 8 to 12 microns.

10. The kit of claim 7, wherein the radiation source and the imager are operative at a range of wavelengths intersecting with a range of wavelengths from 8 to 12 microns.

11. The kit of claim 7, wherein the radiation source and the imager are operative at a range of wavelengths containing a range of wavelengths from 8 to 12 microns.

12. The kit of claim 1, wherein most of inner surface of at least one of the main and auxiliary chambers is diffusively reflective.

13. The kit of claim 12, wherein the inner surface of said auxiliary chamber comprises a highly reflective surface.

14. The kit of claim 13, wherein said highly reflective surface comprises metal.

15. The kit of claim 12, wherein the inner surface of said auxiliary chamber is substantially spherical.

16. The kit of claim 12, wherein the inner surface of said main chamber comprises a highly reflective surface.

17. The kit of claim 12, wherein the inner surface of said main chamber comprises a metal layer.

18. The kit of claim 12, wherein the inner surface of said main chamber is substantially spherical.

19. The kit of claim 1, wherein the reference unit has a cavity with an optical window allowing passage of electromagnetic radiation therethrough into said cavity, the cavity optical window defining said reference surface.

20. The kit of claim 19, wherein most of the inner surface of the cavity is diffusively reflective and configured for diffusive reflection of radiation coming into the cavity through the cavity optical window and further leaving the cavity.

21. The kit of claim 19, wherein the inner surface of said cavity comprises a highly reflective surface.

22. The kit of claim 2, comprising a control system capable of calculating at least one parameter related to the optical property of the sample surface from the obtained image data.

23. The kit of claim 1, comprising a tangible medium carrying a record of a software product preprogrammed for processing image data indicative of intensity distribution of electromagnetic radiation, said software product being capable of calculating at least the intensity distribution of electromagnetic radiation.

24. The kit of claim 23, wherein said software product is further capable of calculating at least one parameter related to the optical property of the sample, said at least one parameter including at least one of the following:
a directional emissivity of the sample;
an emissivity of the sample;
a directional hemispherical reflectivity of the sample;
a reflectivity of the sample;
an intensity of radiation propagating from the sample to the imager;
an intensity of radiation propagating from the reference surface to the imager.

25. The kit of claim 24, wherein said software product utilizes, for the calculation of the directional emissivity of the sample εₛ, a formula
$$\frac{1 - {ɛ}_{s}}{1 - {ɛ}_{r}} = \frac{{i}_{s}^{( 1 )} - {i}_{s}^{( 2 )}}{{i}_{r}^{( 1 )} - {i}_{r}^{( 2 )}} ,$$
wherein
εᵣ is the certain value of the directional emissivity of the reference surface,
iₛ⁽¹⁾ and iₛ⁽²⁾ are, respectively, first and second intensities of radiation propagating from the sample to the imager in cases of a first and a second amounts of radiation reaching said region,
iᵣ⁽¹⁾ and iᵣ⁽²⁾ are, respectively, first and second intensities of radiation propagating from the reference surface to the imager in said cases of the first and the second amounts of radiation reaching said region.

26. The kit of claim 19, wherein the cavity is selected to be of a cylindrical shape with diffuse inner surface, geometrical dimensions of the respective cylinder predetermine the directional emissivity and directional hemispherical reflectivity of the reference surface.

27. The kit of claim 1, comprising a shutter mountable on at least one of said chambers, said shutter being configured and operable to affect a degree of openness of the optical window of at least one of said chambers thereby enabling controlling passage of radiation through this optical window.

28. The kit of claim 1 comprising a set of the reference units, said set defining a set of the reference surfaces at least two of which are of different shapes.

29. The kit of claim 28, comprising at least one of the following:
an imager capable of obtaining image data indicative of intensity distribution of electromagnetic radiation, the imager being operative at wavelength(s) from 8 to 12 microns or at a range of wavelengths intersecting with the range of wavelengths from 8 to 12 microns or at a range of wavelengths containing a range of wavelengths from 8 to 12 microns, said imager to be accommodated so as to have said region in focus;
a tangible medium carrying a record of a software product preprogrammed for processing image data indicative of intensity distribution of electromagnetic radiation, said software product being capable of calculating the intensity distribution of electromagnetic radiation and/or a parameter related to said optical property.

30. The kit of claim 1, comprising a filter passing substantially a spectral band of electromagnetic radiation in which the optical property is to be detected.

31. An apparatus for measuring an optical property of a sample, the apparatus comprising at least one reference unit each having a reference surface of a directional emissivity of a certain value; and main and auxiliary chambers, each of the chambers defining an optical window allowing passage of electromagnetic radiation therethrough, the auxiliary chamber and the main chamber being connected by a shuttable optical pass allowing controllable passage of illuminating radiation from the auxiliary chamber through its optical window into the main chamber through its optical window, the main chamber being configured to define a region thereof for accommodating said reference unit and the sample and being configured to screen this region from external radiation, the apparatus being configured to direct a portion of the illuminating radiation to said region.

32. The apparatus of claim 31, wherein most of inner surface of the main chamber is diffusively reflective.

33. The apparatus of claim 31, wherein the reference unit is positioned so as to accommodate said reference surface within said region and oriented so as to expose said reference surface to at least a portion of the illuminating radiation.

34. The apparatus of claim 32, comprising an imager capable of obtaining images indicative of intensity distribution of electromagnetic radiation, said imager being operative at wavelength(s) from 8 to 12 microns, or at a range of wavelengths intersecting with a range of wavelengths from 8 to 12 microns, or at a range of wavelengths containing a range of wavelengths from 8 to 12 microns, said imager being accommodated so as to have said region in its field of view.

35. The apparatus of claim 34, wherein said imager is configured to be focused on said region.

36. The apparatus of claim 32, comprising a shutter configured and operable to affect a degree of openness of said shuttable optical pass thereby enabling the controllable passage of the illuminating radiation from the auxiliary chamber into the main chamber.

37. The apparatus of claim 36, wherein said shutter is shiftable between its closed state, in which the passage of the illuminating radiation is blocked, and its open state, in which the passage of the illuminating radiation is allowed; said shutter being controllably operable to switch between these states.

38. The apparatus of claim 32, defining a radiation propagation scheme for the illuminating radiation in the shuttable optical pass, the radiation propagation scheme including at least one diffusive reflection or scattering of the illuminating radiation in this pass.

39. The apparatus of claim 32, comprising a radiation source accommodated in said auxiliary chamber, the radiation source being configured and operable for generating illuminating radiation at wavelength(s) from 8 to 12 microns, or at a range of wavelengths intersecting with a range of wavelengths from 8 to 12 microns, or at a range of wavelengths containing a range of wavelengths from 8 to 12 microns.

40. The apparatus of claim 39, defining a radiation propagation scheme for the portion of the illuminating radiation reaching said region, said radiation propagation scheme including at least one diffusive reflection of this radiation in the second chamber before it reaches said region.

41. The apparatus of claim 39, comprising a baffle accommodated in said main chamber, said baffle preventing direct illumination of said region by the illuminating radiation.

42. The apparatus of claim 39, comprising means for controllably changing at least one of a position and an orientation of the sample.

43. The apparatus of claim 39, comprising a tangible medium carrying a record of a software product preprogrammed for processing image data indicative of intensity distribution of electromagnetic radiation, said software product being adapted for calculating the intensity distribution of electromagnetic radiation and/or at least one another parameter related to the optical property of the sample.

44. The apparatus of claim 43, wherein said at least one another parameter related to the optical property of the sample is selected from the following:
a directional emissivity of the sample;
an emissivity of the sample;
a directional hemispherical reflectivity of the sample;
a reflectivity of the sample;
an intensity of radiation propagating from a sample to the imager;
an intensity of radiation propagating from the reference surface to the imager.

45. The apparatus of claim 44, wherein said software product is configured for calculating the directional emissivity of the sample εₛ utilizing a formula
$$\frac{1 - {ɛ}_{s}}{1 - {ɛ}_{r}} = \frac{{i}_{s}^{( 1 )} - {i}_{s}^{( 2 )}}{{i}_{r}^{( 1 )} - {i}_{r}^{( 2 )}} ,$$
wherein
εᵣ is the certain value of the directional emissivity of the reference surface,
iₛ⁽¹⁾ and iₛ⁽²⁾ are, respectively, first and second intensities of radiation propagating from the sample to the imager in cases of a first and a second amounts of radiation reaching said region,
iᵣ⁽¹⁾ and iᵣ⁽²⁾ are, respectively, first and second intensities of radiation propagating from the reference surface to the imager in said cases of the first and the second amounts of radiation reaching said region.

46. The apparatus of claim 39 comprising a set of the reference units, said set of reference units defining a set of reference surfaces at least two of which are of different shapes.

47. The apparatus of claim 36 comprising an imager synchronized with said shutter.

48. The apparatus of claim 31, comprising a filter in said shuttable optical pass, said filter passing substantially a spectral band of electromagnetic radiation in which the optical property is to be detected.

49. A method for measuring an optical property of a sample, the method comprising imaging a region comprising the sample and a reference surface, said reference surface being of a certain value of a directional emissivity, while screening said region from external radiation, said imaging comprising selectively irradiating said region with radiation of a relatively lower and a relatively higher intensity, thereby allowing to obtain image data indicative of intensity distribution of electromagnetic radiation.

50. The method of claim 49, wherein the optical property is at least one of:
a directional emissivity of the sample;
an emissivity of the sample;
a directional hemispherical reflectivity of the sample;
a reflectivity of the sample.

51. The method of claim 49, wherein said electromagnetic radiation is at wavelength(s) from 8 to 12 microns, or at a range of wavelengths intersecting with a range of wavelengths from 8 to 12 microns, or at a range of wavelengths containing a range of wavelengths from 8 to 12 microns.

52. The method of claim 51, performing said imaging with an imager focused on said region.

53. The method of claim 52, comprising analyzing the obtained image data so as to obtain the distribution of intensity of the imaged electromagnetic radiation and/or at least one another parameter related to the optical property of the sample.

54. The method of claim 53, wherein said analyzing comprises calculating the emissivity of the sample εₛ utilizing a formula
$$\frac{1 - {ɛ}_{s}}{1 - {ɛ}_{r}} = \frac{{i}_{s}^{( 1 )} - {i}_{s}^{( 2 )}}{{i}_{r}^{( 1 )} - {i}_{r}^{( 2 )}} ,$$
wherein
εᵣ is the certain value of the emissivity of the reference surface,
iₛ⁽¹⁾ and iₛ⁽²⁾ are, respectively, first and second intensities of radiation propagating from the sample to the imager in cases of a first and a second amounts of radiation reaching said region,
iᵣ⁽¹⁾ and iᵣ⁽²⁾ are, respectively, first and second intensities of radiation propagating from the reference surface to the imager in said cases of the first and the second amounts of radiation reaching said region.

55. The method of claim 51, comprising selecting the reference surface from a set of reference surfaces defined by a set of reference units so as to utilize the certain value of the directional emissivity of the reference surface minimizing an estimate of the error in said optical property of the sample.

56. A reference unit for use in optical measurements of an optical property, the unit defining at least two real surfaces of different shapes covered with materials substantially of the same directional emissivity, and a third virtual surface being defined by said second surface, the directional emissivity of said first surface and the directional emissivity of said third surface being in a predetermined relationship indicative of reflection of light from said first and third surfaces.

57. The reference unit of claim 56, wherein said first surface is planar.

58. The reference unit of claim 56, wherein said second surface is an inner surface of a cylindrical cavity and the third surface is a cross-section of this cavity.

59. The reference unit of claim 56, wherein said first and second surfaces are covered with the same material.

60. The reference unit of claim 56, wherein said first surface is a virtual surface of a cavity.

61. The reference unit of claim 56, wherein said second surface is an inner surface of a square cross-section cavity.
